(19) United States
(12) Patent Application Publication
(10) Pub. No.: US 2025/0367919 A1
(43) Pub. Date: Dec. 4, 2025

(54) VACUUM PLATEN FOR GARMENT DECORATING TECHNIQUE

(71) Applicant: Livingston Systems, LLC, Denver, CO (US)

(72) Inventor: Darren Livingston, Arvada, CO (US)

(21) Appl. No.: 19/221,642

(22) Filed: May 29, 2025

Related U.S. Application Data
(60) Provisional application No. 63/654,476, filed on May 31, 2024.

(51) Int. Cl. B41F 1/32; B41F 16/02

(52) U.S. Cl. CPC B41F 1/32; B41F 16/02

(57) ABSTRACT

A vacuum platen for a printing operation wherein a printable design on a printing sheet or transfer film is transferred from the printing sheet or transfer film to a garment or other printable media. The example vacuum platen includes a printing platen with a first channel between the top surface and the bottom surface of the printing platen. The first channel fluidically connects to the vacuum port and defines a first activatable zone. A second channel between the top surface and the bottom surface of the printing platen fluidically connects to the vacuum port and defines a second activatable zone. A first plurality of openings is provided within the first activatable zone, and a second plurality of openings is provided within the second activatable zone. The first activatable zone and the second activatable zone are selected based on the printing sheet or transfer film for the printing operation.

### PRIORITY CLAIM

This application claims the priority filing benefit of U.S. Provisional Patent Application No. 63/654,476 filed May 31, 2024 for “Vacuum Platen For Garment Decorating Device” of Darren Livingston, hereby incorporated by reference in its entirety as though fully set forth herein.

### BACKGROUND

Printed garments, such as t-shirts, is a big consumer industry, including printed t-shirts for concerts, events, travel destinations, and everyday designs and slogans. Direct to Film (DTF) printing is a relatively new technique that results in durable prints with good color accuracy and detail. DTF printing is preferred for printing photos or detailed designs, although it can be used for any print. DTF printing generally costs less than traditional screen printing, can be completed quickly, and offers a wide range of color options across a variety of different materials. DTF is also advantageous due to the wide variety of garment materials and non-garment media in which it can be applied. Indeed, Direct To Garment (DTG) is somewhat limited to high cotton content garments. DTF is taking a lot of the market from DTG due to being able to essentially hot-glue the ink to about anything. So synthetic athletic garments, all cotton, blends, etc., all work well with DTF. DTF is also used on a lot of other promotional merchandise (“merch”) including metal, plastic, and wood.

The DTF printing operation entails first printing a design onto a transfer film. The ink is then coated with an adhesive. The media to be printed on is placed onto a heat press or similar heat/pressure device, and the DTF transfer film is positioned above the media. While the transfer could be placed first, then the garment/media on top, it would be more difficult to ensure the position is correct since you can't see through most media/shirts. Usually it is the top platen in the heat press clamp that is heated and you want that heat directly onto the transfer. A heat press is used to transfer the design from the transfer film to the garment by heat activating the adhesive. The ink is pressed onto the surface of the garment and generally does not bleed through or feel weighty. DTF prints are smooth and elastic, and are resistant to cracking even with heavy use and washing.

During the DTF printing operation, the operator has to be careful to ensure that the transfer film does not shift or move until the deposition of ink onto the transfer film is finished. If the transfer film moves, the printed design will end up appearing crooked or in the wrong location on the garment.

Vacuum tables with small fans may be used to create a pressure differential under the film to hold the transfer film steady. The high flow of non-positive displacement fans can be used to hold any size film on a “one-size-fits-all” vacuum table, but not effectively. For example, when a smaller transfer film is used, more airflow is pulled through the openings in the vacuum table than those holding the transfer film. Therefore, the transfer film is not held in place very well.

### BRIEF DESCRIPTION OF THE DRAWINGS

FIG. 1 is a perspective view of an example vacuum platen which may be implemented for a garment or other media decorating technique.

FIG. 2 is a close up view of a portion of the example vacuum platen shown in FIG. 1.

FIG. 3 shows top and bottom perspective views of a valve mechanism of the example vacuum platen.

FIGS. 4 and 5 illustrate the example operation of the valve mechanism of the example vacuum platen to select from separate vacuum supply lines.

FIGS. 6 and 7 show an example hose handling system of the example vacuum platen shown in FIG. 1.

FIG. 8 shows an example of a hose control arm of the hose handling system shown in FIGS. 6 and 7.

FIG. 9 illustrates an example operation of the hose control arm of the hose handling system, as shown in FIGS. 6-8.

### DETAILED DESCRIPTION

A vacuum platen is disclosed as it may be implemented for a printing operation during a garment or other media decorating technique such as Direct to Film (DTF) printing wherein a printable design on a printing sheet or transfer film is transferred from the printing sheet or transfer film to a garment or other printable media. A printable design on the printing sheet or transfer film is transferred from the printing sheet or transfer film to a garment or other printable media. A printing sheet or transfer film may be positioned on the platen and held in position by a vacuum during a printing operation.

An example of the vacuum platen includes a printing platen having a top surface and a bottom surface, and a vacuum port on the printing platen. A first channel is provided within the printing platen, between the top surface and the bottom surface of the printing platen. The first channel is fluidically connected (for airflow) to the vacuum port for airflow, and defines a first activatable zone on the printing platen. A first plurality of airflow openings are provided between the first channel and the top surface of the printing platen. A second channel can also be provided between the top surface and the bottom surface of the printing platen. The second channel is fluidically connected (for airflow) to the vacuum port for airflow, and defines a second activatable zone on the printing platen. A second plurality of airflow openings is provided between the second channel and the top surface of the printing platen. Operating the vacuum pump pulls air through the airflow openings on the top surface of the printing platen, and in through the channel(s) back to the vacuum pump to create a suction on the top surface of the platen, thus holding the printing sheet or transfer film against the top surface of the platen.

It is noted that fewer (e.g., one channel) or more channels (more than two channels) can be provided, based on design considerations, such as the size area for holding the printing sheet or transfer film, the suction of the vacuum pump, etc.

The vacuum platen also includes means for selecting between the first channel and the second channel, and hence selecting between the first activatable zone and the second activatable zone. Different zones may be selected based on a size of the printing sheet or transfer film to be held in position on the platelet for the printing operation. That is, the channels may be selected based on the size of transfer film being used so that only those openings in the channel(s) under the transfer film are under vacuum. A smaller activatable zone may be selected for smaller areas for smaller printing sheets or transfer films, and a larger activatable zone may be selected for larger areas for larger printing sheets or transfer films. More than one activatable zone may be selected at the same time (e.g., for larger areas).

It is noted that providing separate activatable zones enables the use of a low-flow/high-pressure positive displacement pump (e.g., a diaphragm pump) to create the vacuum, instead of relying on fans which may not provide a sufficient vacuum.

In an example, the channels are milled into a lower plate of acrylic that forms the platen. The upper plate of the platen is placed over the lower plate (e.g., bonded thereto) to close off and seal the channels between the lower plate and the upper plate. Through-holes through the top surface of the upper plate provide an air passage or access through to the channels formed in the lower plate. These through-holes enable the vacuum or suction on the surface of the platen to hold the printing sheet or transfer paper to the top surface of the platen.

In an example, through-holes may connect microchannels to the channels, providing an air passage into microchannels that can distribute the vacuum or suction to other or distributed areas on the surface of the platen, e.g., where the channels do not reach. For example, the microchannels may provide suction between the channels, outside of the perimeter of the channels, and/or in the central portion of the platen where the mounting hardware secures the platen to the base (e.g., typical on BROTHER™ and EPSON™ brand printers, and Direct to Garment (DTG)—DTF combination machines).

The microchannels are smaller, low-flow “bleeder” channels that may be provided between selectable zones to provide suction in common areas covered by the sheet size. The microchannels extend the vacuum to these zones that are beyond the channels themselves, over other channels, and over areas of the printing platen that are not otherwise provided with suction from the openings that are provided directly to the channels. The additional vacuum or suction provided by the microchannels allows for the transfer film to lay flatter. In addition, the microchannels may extend outside of the perimeter of the transfer film, and do not create as strong of a vacuum such that it would “break the seal” between the transfer film at the top surface of the printing platen.

In an example, the vacuum channels may be concentric to each other. In an example, the microchannels are non-concentric. The channels and microchannels define the user activatable zones. These activatable zones can correspond to commonly available printable sheet sizing (e.g., size large and size small). In an example, the vacuum platen includes a valve mechanism to selectively connect a vacuum port to each channel, and hence to the different activatable zones.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

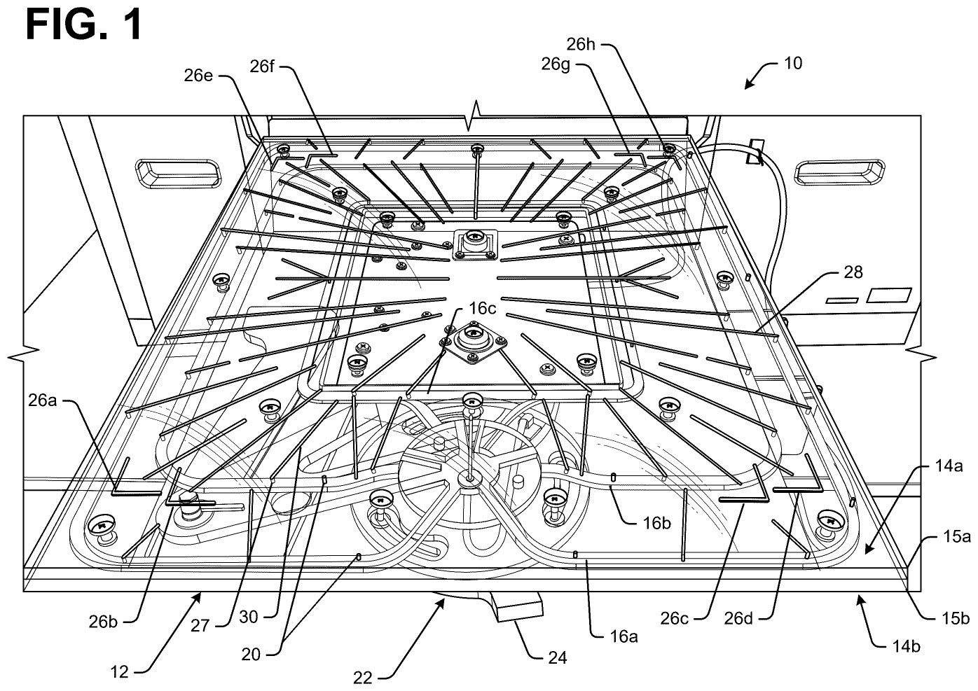

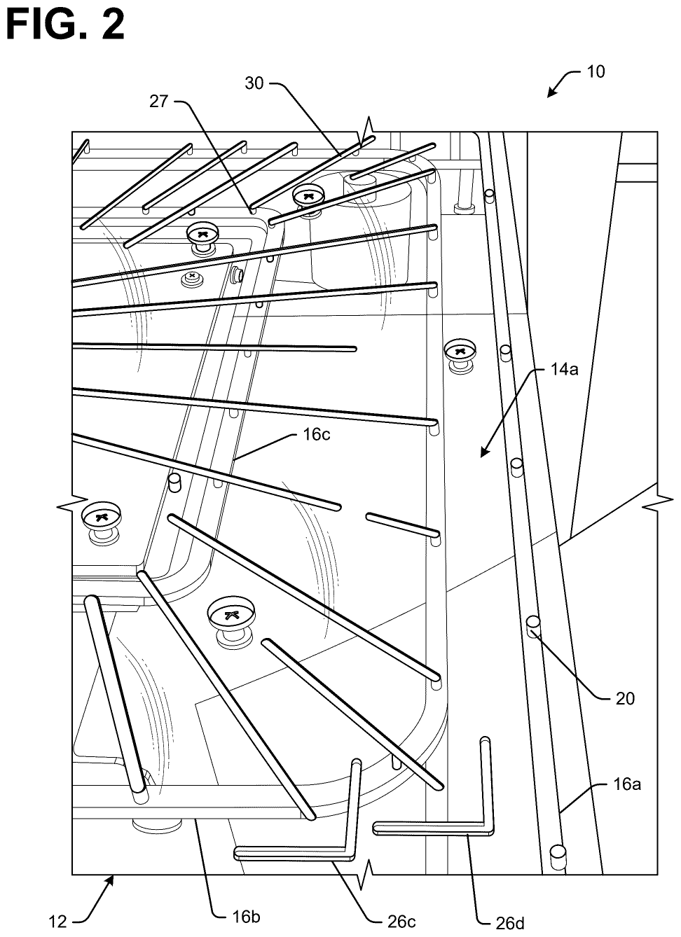

FIG. 1 is a perspective view of an example vacuum platen 10 which may be implemented for a garment or other media decorating technique. FIG. 2 is a close up view of a portion of the example vacuum platen 10 shown in FIG. 1. The example vacuum platen 10 may be implemented for a printing operation of a garment or other media decorating technique, wherein a printable design on a printing sheet or transfer film is transferred from the printing sheet or transfer film to a garment or other printable media. It is noted that although a specific configuration of the vacuum platen is shown, other configurations are contemplated, as will be readily apparent to those having ordinary skill in the art after becoming familiar with the teachings herein.

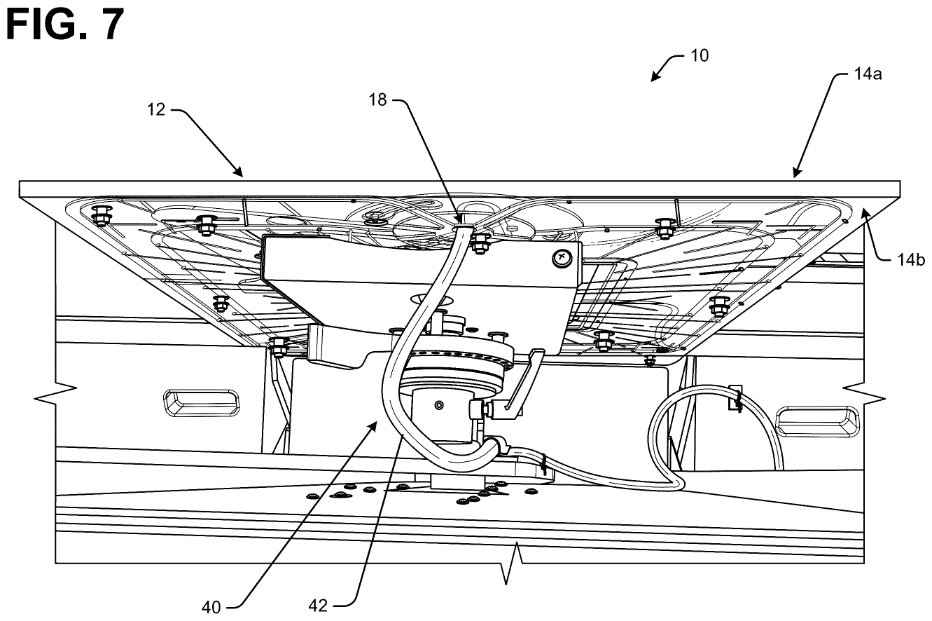

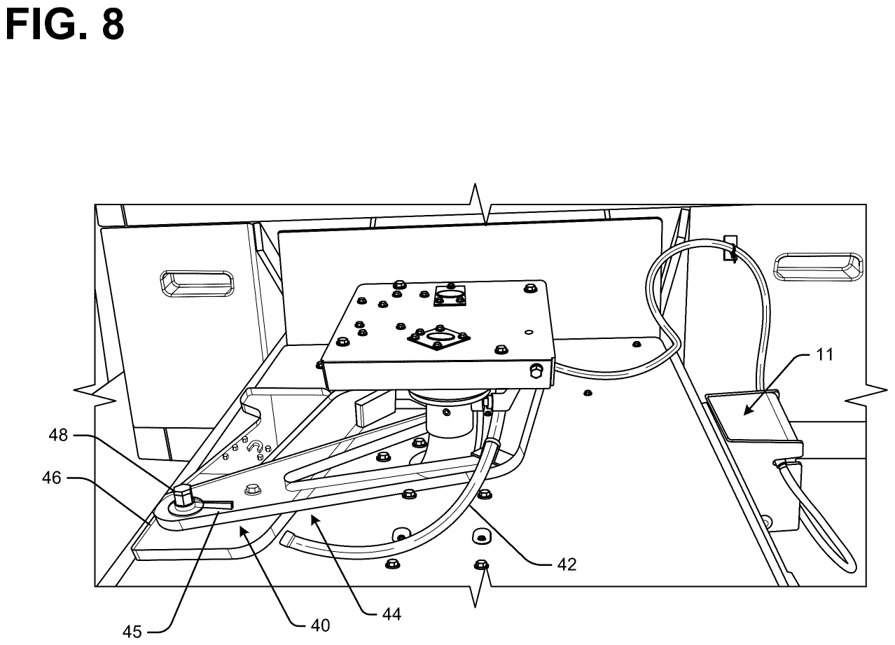

An example vacuum platen 10 includes a printing platen 12 having a top surface 14a and a bottom surface 14b. One or more channels 16a-c are provided for airflow within the printing platen 12. The airflow may be generated by a vacuum pump 11 (see, e.g., FIG. 8). In an example, the first channel 16a is provided within the printing platen between the top surface 14a and the bottom surface 14b of the printing platen 12, and is fluidically connected (for airflow) to a vacuum port 18 (see, e.g., FIG. 7). The vacuum port 18 is connected via a vacuum hose to the vacuum pump.

The first channel 16a defines a first activatable zone on the top surface 14a of the printing platen 12. The printing platen 12 may have at least one more channel (e.g., a second channel 16b), and in FIG. 1 a third channel 16c is also shown. Each printing channel 16a-c is provided within the printing platen 12 between the top surface and the bottom surface of the printing platen 12. Each printing channel 16a-c is fluidically connected, albeit separately, to the vacuum port 18. The second channel 16b defines a second activatable zone on the top surface of the printing platen, and the third channel 16c defines a third activatable zone, and so forth.

The term “activatable zone” as used herein refers to the area on the platen surface that is under vacuum or suction. Each activatable zone is defined by the perimeter of the channel(s) and/or any corresponding microchannels providing the suction. An activatable zone may include more than one channel (e.g., channels 16b and 16c; or channels 16a, b, and c).

A plurality of channel openings 20 are provided between the channels 16a-c and the top surface 14a of the printing platen 12. During operation, airflow is pulled through the channel openings 20 under vacuum, through the corresponding channels 16a-c to the vacuum pump, thus creating the vacuum on the surface of the platen 12 to secure the printing sheet or transfer film against the top surface 14a of the platen 12. The vacuum port may be connected to a vacuum pump, such as but not limited to a low-flow/high-pressure positive displacement pump (e.g., a diaphragm pump).

A valve mechanism 22 is provided for the user to select (e.g., by moving handle 24) between the channels 16a, 16b, and/or 16c corresponding to the activatable zones. Selection of an activatable zone may be based on a size of the printing sheet or transfer film for the printing operation. By adjusting which channels are utilized (e.g., by selecting an activatable zone), operators can fine-tune suction coverage to substantially match specific film dimensions, thereby enhancing adaptability and efficiency in various printing applications.

During the printing operation, a printable design on the printing sheet or transfer film is transferred from the printing sheet or transfer film to a garment or other printable media. In an example, a printing sheet or transfer film may be positioned on the platen 12, and optionally aligned using one or more of the ridged guides 26a-h (e.g., L-shaped guides) provided in the corners corresponding to different size printing sheets or transfer films. This structured approach helps ensure that vacuum pressure or suction is applied where needed, optimizing the overall image transfer process.

Before continuing, it is noted that indentations or “finger depressions” can be formed in the surface of the platen to enable the user's fingers or fingernails to get under the printing sheet or transfer film. These finger depressions may help facilitate lifting the printing sheet or transfer film off of the platen following a printing operation.

In an example, the top surface 14a of the printing platen 12 is on a first platen portion 15a, and the bottom surface 14b of the printing platen 12 is on a second platen portion 15b. The first platen portion 15a is assembled together with the second platen portion 15b to form the printing platen 12. In an example, the first platen portion 15a is bonded and/or separately sealed together with the second platen portion 15b. For example, the first platen portion 15a can be bonded, adhered or otherwise connected together (e.g., using mechanical fasteners with a sealant to seal the channels) with the second platen portion 15b to form the printing platen 12. This approach provides a sealed environment for vacuum control while maintaining structural integrity of the platen. It is also easier to manufacture, although other manufacturing methods may also be used wherein the channels are formed within the platen (e.g., by injection molding).

In an example, the channels 16a-c are machined in the first platen portion 15a and/or the second platen portion 15b prior to connecting these together to form the platen 12. After assembling these together to form the platen 12, the channels 16a-c are formed between the top surface 14a and the bottom surface 14b of the printing platen 12. The channels 16a-c can be machined in either or both of the platen portions 15a, 15b. The channels 16a-c can be machined as substantially square or rectangular shaped channels, although the channels 16a-c may have any suitable shape (e.g., circular, semi-circular, triangular, etc.). The channels 16a-c can also be different sizes, for example, to provide more or less suction in certain areas of the printing platen (e.g., around the perimeter of the transfer film).

In an example, the channels 16a-c are concentric to each other, meaning they share a common center and extend outward in a controlled arrangement. This concentric configuration allows for selective activation of different activatable zones based on the size and shape of the transfer material.

The channels 16a-c can be precisely shaped and sealed to optimize airflow efficiency. The channels 16a-c help maintain consistent suction power and prevent air leakage, ensuring reliable performance throughout the printing process.

In an example, the vacuum platen 10 includes at least one surface channel or microchannel 28. It is noted that the term “microchannel” is not limited to any particular size (e.g., less than 1 mm in diameter). Instead, the term “microchannel” is used herein as a differentiator from the primary channels 16a-c. The microchannels 28 may be any suitable size, typically less than the size of the primary channels 16a-c. In addition, the channels 16a-c and the microchannels 28 do not need to be the same size. For example, channel 16a may be a different size (and/or shape) than channel 16b, and so forth. Indeed, the entire length of the channels 16a-c and microchannels 28 do not need to be the same size (and/or shape), and each channel 16a-c and/or microchannel 28 can have varying size (e.g., diameter) and/or shape along the length thereof.

A plurality of microchannels 28 are shown in the drawings. The microchannels 28 are open (at least in part) to the top surface of the printing platen 12, thereby being configured to provide additional suction on the printing media. The microchannels 28 fluidically connect to at least one of the channels 16a-c. The microchannels 28 on the top surface of the printing platen 12 are fluidically connected to at least one of the channels 16a-c via an opening 27 formed therebetween. The microchannels 28 extending from the primary vacuum channels 16a-c refine airflow distribution across the top surface 14a of the platen 12. This connection is facilitated through strategically positioned openings that allow airflow from the channels.

The inclusion of microchannels 28 serve to extend the vacuum's reach beyond the primary channels 16a-c, and can be said to create another activatable zone. This activatable zone formed by the microchannels 28 is defined by its placement relative to the first and second activatable zones. Depending on the configuration of the platen 12, it may exist inside the perimeter of the first activatable zone, between the first and second activatable zones, or outside the perimeter of the second activatable zone. By introducing these additional zones, the system enhances adaptability, allowing operators to secure a wider range of transfer film sizes and shapes without requiring physical modifications to the platen 12.

The microchannels 28 also contribute to improving vacuum efficiency by ensuring even distribution of suction force across the surface 15a of the platen 12. Their ability to extend vacuum coverage makes it possible to activate specific regions based on the needs of a particular printing task, increasing film adherence to the surface 15a of the platen 12, and reducing unwanted movement. Furthermore, the design of the microchannel 28 can be carefully constructed to ensure minimal airflow obstruction, preventing air pockets or weak suction areas that could negatively impact the transfer process.

In an example, the vacuum platen 10 includes at least one bleeder channel 30. The bleeder channel 30 can be a microchannel that is connected for airflow between two or more channels 16a-c. The bleeder channel 30 serves as a low flow channel. That is, the bleeder channel 30 balances airflow between vacuum channels (e.g., between 16a and 16b, or 16b and 16c, or between 16a and 16c or between 16a, 16b and 16c). The bleeder channel 30 provides a controlled and low-flow passage of air. Unlike the primary vacuum channels 16a-c, which are responsible for generating the suction force necessary for securing the transfer film or printing sheet, the bleeder channel(s) 30 provide a pressure equalization pathway. The bleeder channel(s) 30 ensures a stable and gradual transition of airflow between the channels 16a-c, minimizing abrupt fluctuations in suction pressure.

By serving as a low-flow channel, the bleeder channel(s) 30 help maintain a consistent vacuum environment within the platen 12. This can be particularly beneficial when switching between different channel configurations 16a-c, as it prevents sudden loss or oversaturation of vacuum force. The controlled airflow through the bleeder channel(s) 30 can also aid in the efficient evacuation of minor leaks or gaps within the printing setup, ensuring that the transfer film remains securely positioned throughout the process.

Additionally, the bleeder channel(s) 30 can be designed with a specific geometry to optimize performance. It may feature a narrower passage than the primary vacuum channels 16a-c to regulate airflow more precisely while still allowing enough connection between the main channels 16a-c. This design ensures that even when only one of the main vacuum channels 16a-c is activated, a slight level of airflow is maintained in the adjacent channel, contributing to smoother operation and greater flexibility in vacuum control. In practical application, this feature also enhances adaptability of the platen 12 to various transfer film sizes and printing operations by providing an intermediate airflow path.

In an example, the bleeder channel 30 is configured (e.g., sized and/or shaped) as a low flow channel to provide airflow to common areas of the printing platen covered by a sheet size to accommodate a flatter print media. That is, the flatter print media may increase the vacuum below shared areas. The bleeder channel 30 that might be outside of the area of the printing sheet or transfer film provides some relief from this additional vacuum, but not enough that it breaks the seal with the printing media.

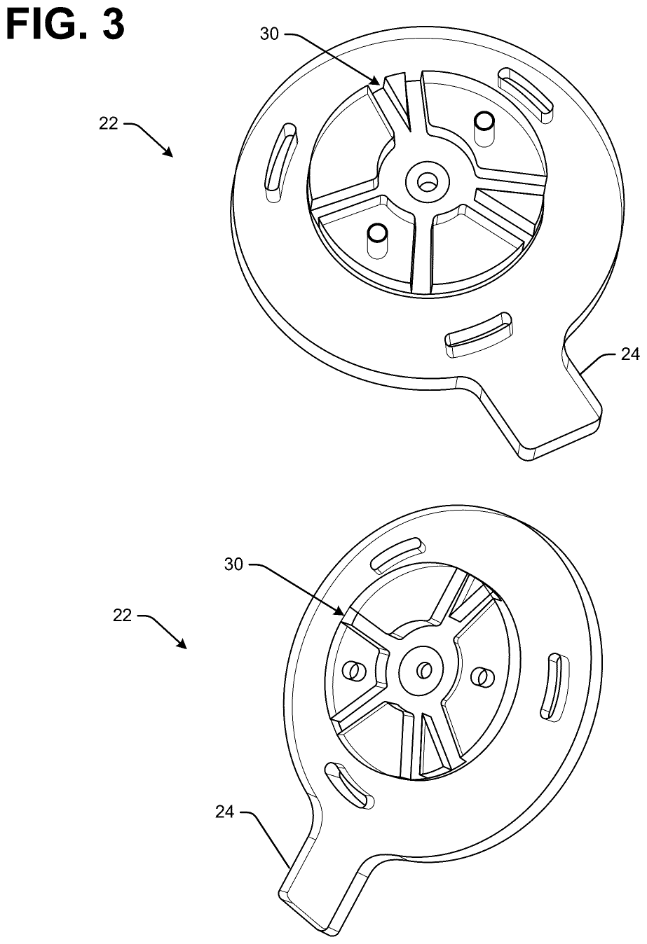

FIG. 3 shows top and bottom perspective views of a valve mechanism 22 of the example vacuum platen 10. The valve mechanism 22 allows the operator control over providing the airflow to accommodate different sizes and shapes of transfer film or printing sheets. The valve mechanism 22 includes a plurality of selectable channels 30 formed therethrough, each enabling different fluidic (airflow) connections or flow paths between the vacuum port 18 (FIG. 7) and the selected channel configuration(s).

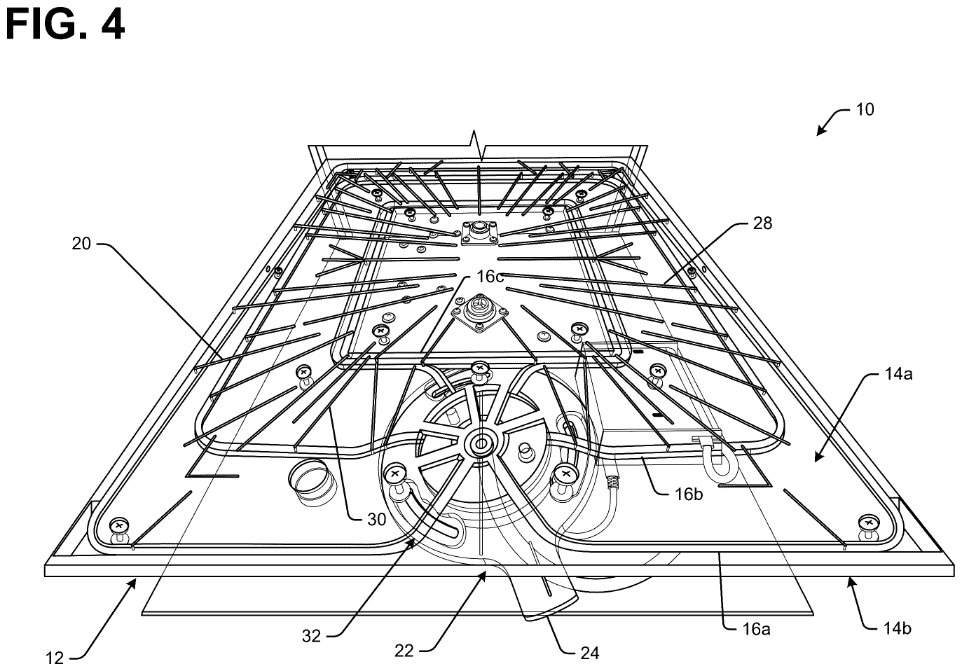

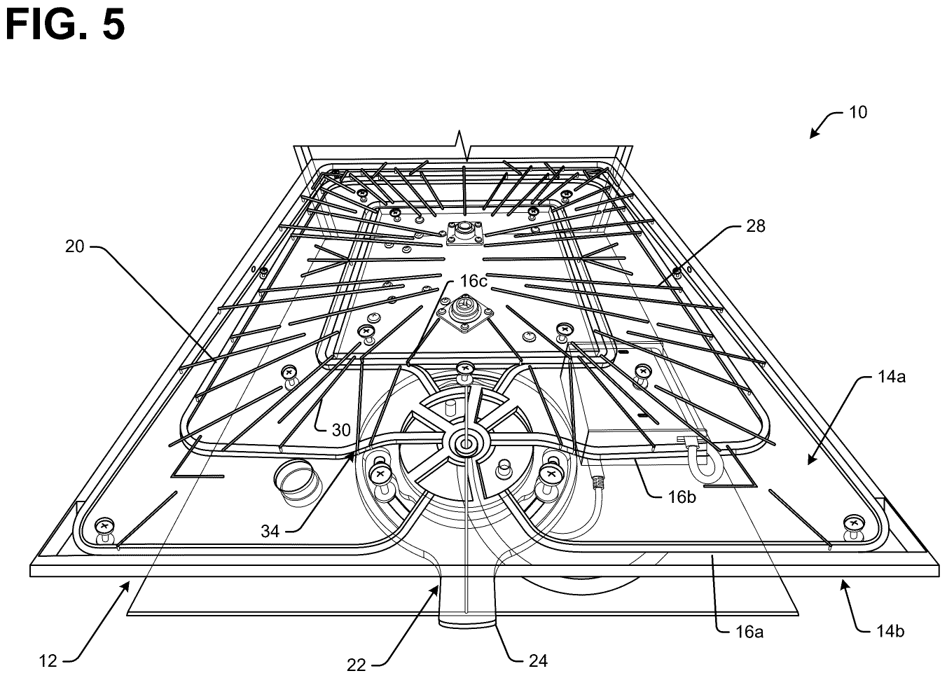

FIGS. 4 and 5 illustrate the example operation of the valve mechanism 22 of the example vacuum platen 10 to select from separate vacuum supply lines, each enabling different airways or flow paths. By rotating the valve mechanism 22 (e.g., using handle 24, or by automated means such as a motor), the operator can fluidically connect the vacuum port 18 to the first channel 16a in one mode (reference 32 in FIG. 4), the second channel 16b in another mode (reference 34 in FIG. 5), the third channel 16c in another mode, and so forth. The operator can also connect two or more channels 16a-c simultaneously when broader suction coverage is required. The ability to rotate the valve mechanism 22 ensures that only the necessary channels 16a-c are activated, optimizing vacuum performance based on the transfer film's dimensions.

The valve system facilitates precise selection of activatable zones, directing vacuum pressure to specific areas as needed. This design provides efficiency and flexibility during printing operations by allowing adjustments without requiring hardware modifications. The valve system supports multiple printing sheet sizes, improving adhesion and positioning of transfer films to achieve high-quality image transfers. This functionality ensures that operators can easily adapt to different printing requirements while maintaining efficiency and accuracy.

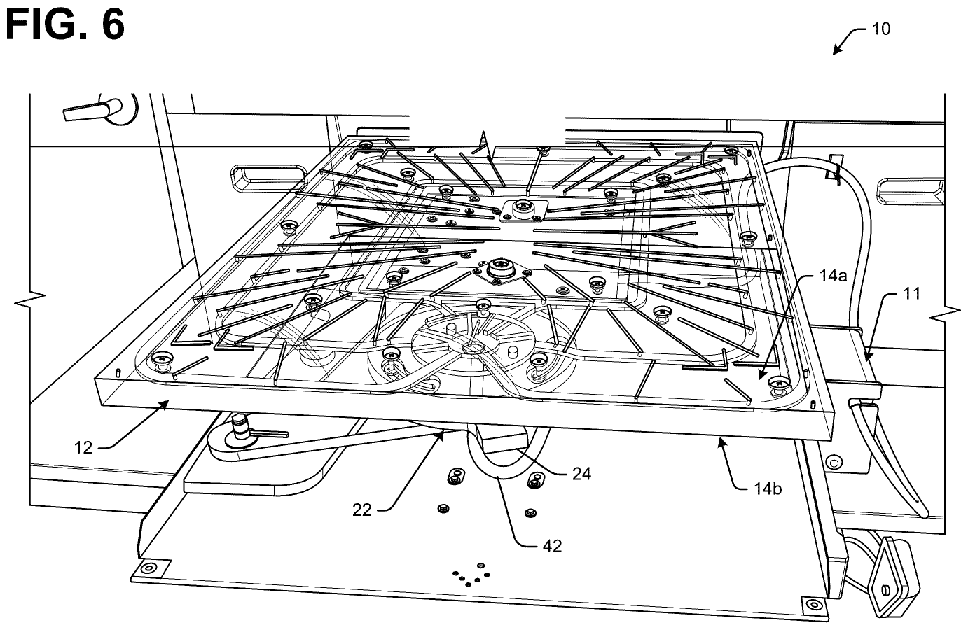

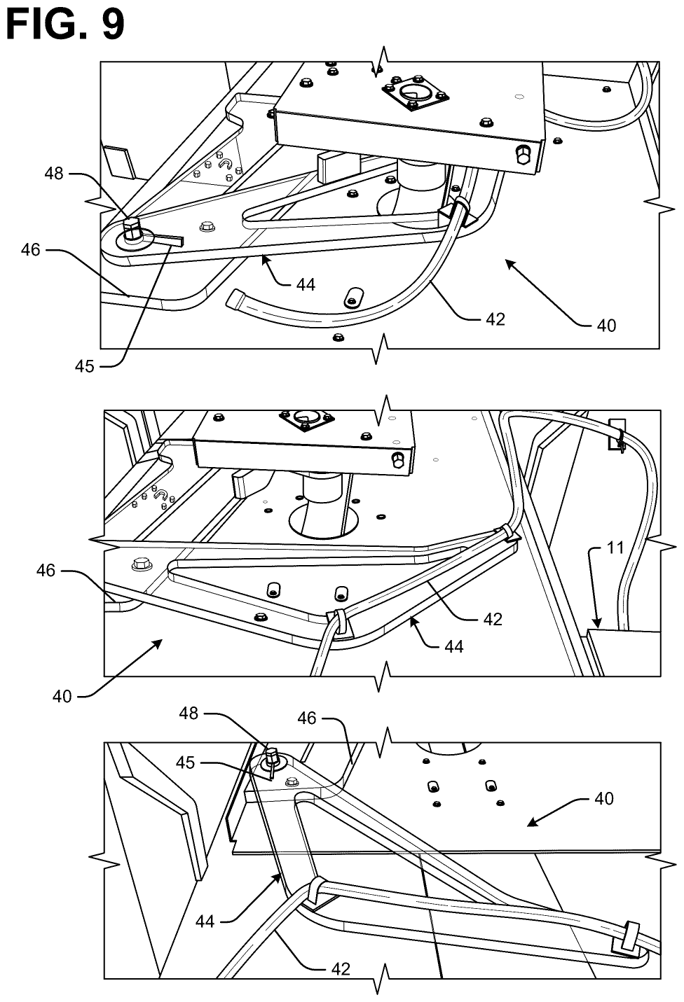

FIGS. 6 and 7 show an example hose management system or hose handling system 40 for handling a hose 42 from a vacuum pump 11 (FIG. 8) to the host port 18 (FIG. 7) of the example vacuum platen 10. FIG. 8 shows an example of a hose control arm 44 of the hose handling system 40 shown in FIGS. 6 and 7. FIG. 9 illustrates an example operation of the hose control arm 44 of the hose handling system 40, as shown in FIGS. 6-8.

In an example, the hose handling system 40 includes a bracket assembly 46 for mounting below the printing platen 12. A moveable arm 44 is rotationally attached to the bracket assembly 46. In an example, a biasing element is also provided that automatically returns the arm mechanism 44 to its default position when not actively engaged by platen 12 movement. In an example, the moveable arm 44 is attached via a spring biasing member to default in a first position. The movable arm 44 rotates to a second position during operation. As such, the hose handling system 40 moves the air supply hose 42 during a printing operation to prevent the hose 42 from becoming entangled.

The bracket assembly 46 is mounted beneath the printing platen 12 and serves as the foundation for the hose management system. This assembly provides a pivot point 48 for the movable arm 44, allowing it to rotate as needed (as seen, e.g., in FIG. 9). The movable arm 44 is rotationally attached to the bracket assembly 46, enabling it to pivot between multiple positions. When the platen 12 is at rest, the arm 44 remains in its default first position, kept in place by a biasing element. As the platen 12 moves, the moveable arm 44 shifts to accommodate hose 42 during the printing process, prompting the movable arm 44 to rotate through positions and move the hose 42 along with it, maintaining alignment and preventing tangling.

In an example, the moveable arm 44 can be biased back to its first position by a spring mechanism 45. The spring 45 provides controlled resistance and ensures the moveable arm 44 returns smoothly when platen 12 movement ceases. However, alternative mechanisms can be used instead of a spring. An example is a counterweight system, where a weight pulls the arm back into place when movement stops. Another example is a pneumatic actuator, which uses compressed air to control the movement of the arm, allowing adjustments based on platen motion. Additionally, a motorized system with sensors can dynamically reposition the arm to optimize hose handling while providing more advanced movement control. The hose handling system 40 ensures smooth operation by preventing entanglement and maintaining a reliable vacuum supply during the printing operation.

It should be noted that the vacuum platen 10 can accommodate different power sources, for example, one powered by AC electricity and another operating on a battery. Users who require continuous, high-volume printing with minimal manual intervention may benefit from the AC-powered platen. Meanwhile, users who prioritize mobility, energy efficiency, and a simpler setup may find the battery-powered version more suitable. As such, the vacuum platen can accommodate different workflow requirements.

In the AC-powered version, energy consumption is not a major concern, allowing for the integration of a hose handling system 40. As explained above, the hose handling system 40 ensures that the supply hose 42 moves smoothly in conjunction with the platen 12, preventing entanglement while maintaining an uninterrupted vacuum supply. Since the platen 12 is connected to a reliable AC power source, the hose control arm 44 movement can be mechanized without the need to conserve energy. This version offers a more automated and efficient printing process, reducing manual hose 42 adjustments and improving workflow.

In an example, the battery operated platen may be provided without a hose handling system 40 for energy efficiency. A battery-powered version of the vacuum platen 10 prioritizes energy conservation, as frequent recharging would be inconvenient for daily operations. To simplify the design and minimize moving components, this version does not include a moveable arm 44. Instead, the hose 42 is attached directly to the platen 120 itself, allowing it to move passively without requiring additional energy input. While this approach removes an automated hose handling system 40, it reduces overall power consumption so that users do not need to recharge the battery frequently. This design makes the battery-powered platen more compact and cost-effective, catering to users who prioritize simplicity and reduced maintenance. It is noted of course, that the implementation of a hose handling system 40 is not dependent on the power source. A battery operated vacuum platen may be provided with a hose handling system 40 and an AC powered vacuum platen may be provided without a hose handling system 40.

It is noted that the examples shown and described are provided for purposes of illustration and are not intended to be limiting. Still other examples are also contemplated.

1. A vacuum platen for a printing operation wherein a printable design on a printing sheet or transfer film is transferred from the printing sheet or transfer film to a garment or other printable media, comprising:
a printing platen having a top surface and a bottom surface;
a vacuum port on the printing platen;
a first channel provided within the printing platen between the top surface and the bottom surface of the printing platen, the first channel fluidically connected to the vacuum port, the first channel defining a first activatable zone on the top surface of the printing platen;
at least a second channel provided within the printing platen between the top surface and the bottom surface of the printing platen, the second channel fluidically connected to the vacuum port, the second channel defining a second activatable zone on the top surface of the printing platen;
a first plurality of openings provided within the first activatable zone between the first channel and the top surface of the printing platen;
a second plurality of openings provided within the second activatable zone between the second channel and the top surface of the printing platen; and
means for selecting between the first activatable zone and the second activatable zone based on a size of the printing sheet or transfer film for the printing operation.

2. The vacuum platen of claim 1, wherein the top surface of the printing platen is on a first platen portion and the bottom surface of the printing platen is on a second platen portion, the first platen portion assembled together with the second platen portion to form the printing platen having the top surface and the bottom surface.

3. The vacuum platen of claim 2, wherein the first platen portion is bonded together with the second platen portion.

4. The vacuum platen of claim 2, wherein the first channel and the second channel are machined in at least one of the first platen portion and the second platen portion and are thereby provided between the top surface of the printing platen and the bottom surface of the printing platen when the first platen portion is assembled together with the second platen portion.

5. The vacuum platen of claim 4, wherein the first channel and the second channel are machined in both the first platen portion and the second platen portion.

6. The vacuum platen of claim 4, wherein the first channel and the second channel are machined as substantially square or rectangular shaped channels.

7. The vacuum platen of claim 1, wherein the first channel and the second channel are concentric to each other.

8. The vacuum platen of claim 1, wherein the means for selecting includes a valve mechanism with a plurality of selectable channels formed therein for fluidically connecting the vacuum port in a first operating mode to the first channel, and in a second operating mode to the second channel.

9. The vacuum platen of claim 1, wherein the means for selecting includes a valve mechanism with a plurality of selectable channels formed therein for fluidically connecting the vacuum port to both of the first channel and the second channel simultaneously.

10. The vacuum platen of claim 1, further comprising at least one bleeder channel fluidically connecting the first channel and the second channel.

11. The vacuum platen of claim 10, wherein the at least one bleeder channel is a low flow channel.

12. The vacuum platen of claim 1, further comprising at least one surface channel open to the top surface of the printing platen, the at least one surface channel fluidically connected to at least one of the first channel and the second channel.

13. The vacuum platen of claim 12, wherein the at least one surface channel on the top surface of the printing platen is fluidically connected to at least one of the first channel and the second channel via an opening formed therebetween.

14. The vacuum platen of claim 12, wherein the at least one surface channel on the top surface of the printing platen extends the vacuum to provide at least a third activatable zone.

15. The vacuum platen of claim 14, wherein the third activatable zone is defined as at least one of: inside of a perimeter of the first activatable zone, between the first activatable zone and the second activated zone, and outside of a perimeter of the second activatable zone.

16. The vacuum platen of claim 12, wherein the at least one surface channel on the top surface of the printing platen extends the vacuum over other channels.

17. The vacuum platen of claim 12, wherein the at least one surface channel on the top surface of the printing platen extends the vacuum beyond the first channel and the second channel.

18. The vacuum platen of claim 1, further comprising a hose handling system having a bracket assembly for mounting below the printing platen, and a moveable arm rotationally attached via a spring biasing member to default in a first position, the movable arm rotating to a second position during operation, the hose handling system moving a supply hose during a printing operation.

19. A vacuum platen for a printing operation wherein a printable design on a printing sheet or transfer film is transferred from the printing sheet or transfer film to a garment or other printable media, comprising:
a printing platen having a top surface and a bottom surface;
a vacuum port on the printing platen;
a first channel provided within the printing platen between the top surface and the bottom surface of the printing platen, the first channel fluidically connected to the vacuum port, the first channel defining a first activatable zone on the top surface of the printing platen;
at least a second channel provided within the printing platen between the top surface and the bottom surface of the printing platen, the second channel fluidically connected to the vacuum port, the second channel defining a second activatable zone on the top surface of the printing platen;
a first plurality of openings provided within the first activatable zone between the first channel and the top surface of the printing platen;
a second plurality of openings provided within the second activatable zone between the second channel and the top surface of the printing platen;
a plurality of microchannels formed in the top surface of the printing platen and open to the top surface of the printing platen, the plurality of microchannels fluidically connected to at least one of the first channel and the second channel; and
means for selecting between the first channel and the second channel based on the printing operation.

20. The vacuum platen of claim 1, further comprising a hose handling system having a bracket assembly for mounting below the printing platen, and a moveable arm rotationally attached via a spring biasing member to default in a first position, the movable arm rotating to a second position during operation, the hose handling system moving a supply hose during a printing operation.
